(19) United States
(12) Patent Application Publication
(10) Pub. No.: US 2007/0106985 A1
(43) Pub. Date: May 10, 2007

(54) Apparatus for loading firmware into integrated circuit

(76) Inventors: Chih Kang Pan, Taipei City (TW); Wu Ping Hung, Sinjhuang City (TW); Hsiang-Chi Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/452,193

(22) Filed: Jun. 14, 2006

(30) Foreign Application Priority Data
Nov. 10, 2005 (TW) 094219455

(51) Int. Cl. G06F 9/445

(52) U.S. Cl. 717/174

(57) ABSTRACT

An apparatus for loading firmware into IC is provided, including a USB connector, at least a USB controller, a conversion interface, a plurality of connection interfaces, a plurality of non-volatile memories, and a plurality of IC slots. The USB connector provides the connection to any electronic USB device. The USB controller is connected to the USB connector for loading the original firmware data for the IC from the USB device. The conversion interface is connected to the USB controller for data format conversion of original firmware data between USB interface and conversion interface. The connection interfaces are connected to the conversion interface and the non-volatile memories are connected to the respective connection interfaces for storing the converted firmware data. The IC slots are connected to respective non-volatile memories so that the firmware stored in the non-volatile memories can be loaded into the ICs plugged in the IC slots. In this way, the apparatus achieves the object that the firmware is only loaded once for loading into multiple ICs, and it is unnecessary for the burner to be always connected to the computer host during the loading.

### BACKGROUND OF THE INVENTION

1. Field of the Invention

The present invention relates to an apparatus for loading firmware into an integrated circuit (IC) and, more particularly, to an apparatus for loading firmware once for performing multiple loadings into a plurality of ICs.

2. The Related Arts

The computer manufacturers must load, or called “burn”, firmware into an integrated circuit (IC) before shipping or during product maintenance and replacement. There are two conventional methods for loading firmware into an IC. The first is to use a specialized one-to-many burner to load the firmware into the IC. The second is to use a custom made fixture for loading firmware into one IC at a time.

The above-discussed conventional specialized burners have the major disadvantage of costs. Another disadvantage is the burner must always be connected to a computer during the loading so that the computer can load the firmware into the IC. This makes the loading process complicated and inconvenient. If the computer is disconnected from the burner, the entire loading process is rendered a failure. In addition, because the conventional multi-port burner needs to load different firmware from the computer for different IC, and the size of a burner is usually bulky, and therefore, the application scope and functions of the conventional multi-port burner are limited.

On the other hand, the conventional single-slot fixture has the disadvantage that only one IC can be loaded at a time. For mass production, this is certainly a costly and time-consuming alternative.

### SUMMARY OF THE INVENTION

The present invention is made to overcome the aforementioned disadvantages of the conventional techniques. The primary object of the present invention is to provide an apparatus for loading firmware into an IC. The apparatus of the present invention comprises at least a universal serial bus (USB) connector and a USB controller so that the firmware can be loaded into the IC from any electronic device with a USB connection, such as card reader, flash disk, personal digital assistant (PDA), mobile phone, desktop personal computer or notebook computer. This provides better convenience and flexibility.

Another object of the present invention is to provide an apparatus for loading firmware into an IC, including a conversion interface, a plurality of connection interfaces, a plurality of non-volatile memories and a plurality IC slots. The conversion interface is connected to a USB controller for loading and converting the original firmware data, and the connection interfaces are connected to the conversion interface and the non-volatile memories. The non-volatile memories are connected to the IC slots, respectively, so that the firmware data can be stored into the non-volatile memories through the conversion interface and connection interfaces. Then, the firmware data are loaded from the non-volatile memories into the ICs plugged in the IC slots. In this way, the firmware is loaded into the non-volatile memories only once, and a plurality of ICs can be loaded from the non-volatile memories. This will save both time and manpower.

Yet another object of the present invention is to provide an apparatus for loading firmware into IC, where the updating of the firmware can be accomplished by loading the new firmware into the non-volatile memories through any electronic device with a USB connector, such as card reader, flash disk, PDA, mobile phone, PC, notebook PC, and so on. This provides better efficiency and flexibility.

To achieve the above objects, the present invention provides an apparatus for loading firmware into an IC, comprising a USB connector, at least a USB controller, a conversion interface, a plurality of connection interfaces, a plurality of non-volatile memories, and a plurality of IC slots. The USB connector provides the connection to any electronic USB device. The USB controller is connected to the USB connector for loading the original firmware data for the IC from the USB device. The conversion interface is connected to the USB controller for data format conversion of original firmware data between USB interface and conversion interface. The connection interfaces are connected to the conversion interface and the non-volatile memories are connected to the respective connection interfaces for storing the converted firmware data. The IC slots are connected to respective non-volatile memories so that the firmware stored in the non-volatile memories can be loaded into the ICs plugged in the IC slots. In this way, the present invention achieves the object that the firmware is only loaded once for loading into multiple ICs, and it is unnecessary for the burner to be always connected to the computer host during the loading.

The present invention is to eliminate the disadvantages of the conventional methods by using multi-port or single-port burner for loading firmware into ICs. The present invention allows loading firmware from any electronic USB devices, such as card reader, flash disk, PDA, mobile phone, desktop computer, notebook computer, and so on.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system block diagram of a first embodiment in accordance with the present invention;

FIG. 2 is a system block diagram of a second embodiment in accordance with the present invention; and

FIG. 3 is a system block diagram of a third embodiment in accordance with the present invention.

### DETAILED DESCRIPTION OF THE PREFERRED EMBODIMENTS

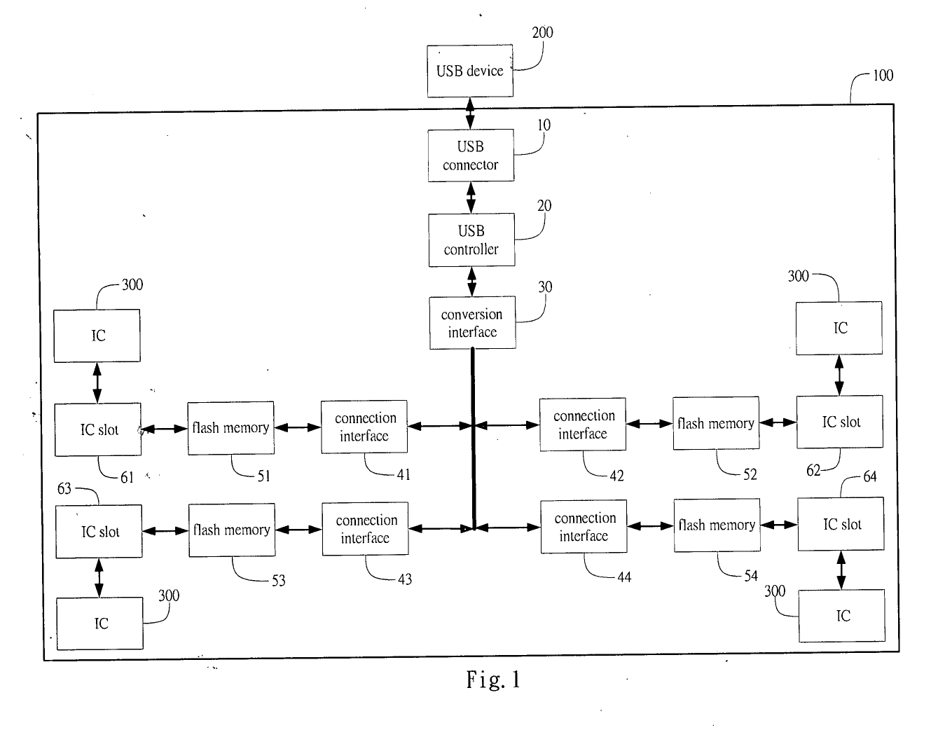

With reference to the drawings and in particular to FIG. 1, which shows a first embodiment in accordance with the present invention, an apparatus 100 for loading firmware into an IC in accordance with the present invention comprises at least a universal serial bus (USB) connector 10, at least a USB controller 20, a conversion interface 30, a plurality of connection interfaces 41, 42, 43, 44, a plurality of flash memories 51, 52, 53, 54, and a plurality of IC slots 61, 62, 63, 64. The USB connector 10 provides a connection to a USB device 200. The USB device 200 is not limited to any specific type. The present embodiment uses a flash disk as an example. Other USB devices, such as card reader, personal digital assistant (PDA), mobile phone, desktop computer, and notebook computer, are also within the scope of the present invention. The USB device 200 is for storing the original firmware for loading into an IC 300.

The USB controller 20 is connected to the USB connector 10 for loading firmware for the IC 300 from the USB device 200. The USB controller 20 comprises the functions of on-the-go (OTG) data transmission storage control and data loading (burn) control. The USB controller 20 is not limited to any specific type. The present invention uses USB OTG controller as an embodiment, but other equivalent USB controllers can also be used.

The conversion interface 30 is connected to the USB controller 20 for converting the original firmware from the USB interface format to another corresponding interface format. The conversion interface 30 is not limited to any specific type. The present invention uses USB parallel interface as an embodiment for explanation. Other equivalent types, such as USB serial interface or USB I/O interface, are also within the scope of the present invention.

The connection interfaces 41, 42, 43, 44 are connected to the conversion interface 30 for loading the converted firmware data through the conversion interface 30. The connection interfaces 41, 42, 43, 44 correspond to the conversion interface 30. In this embodiment, the parallel interfaces are used for explanation. Other equivalent types, such as serial interfaces, or I/O interfaces are also within the scope of the present invention.

The non-volatile memories 51, 52, 53, 54 are connected to respective connection interfaces 41, 42, 43, 44 for storing the firmware for the IC 300. The non-volatile memories 51, 52, 53, 54 are not limited to any specific type. The present invention uses flash memory as an embodiment for explanation.

The IC slots 61, 62, 63, 64 are connected to respective non-volatile memories 51, 52, 53, 54. Each IC slot 61, 62, 63, 64 provides a slot for an IC 300 to plug in so that each IC 300 can load (burn) the firmware through respective non-volatile memories 51, 52, 53, 54.

In actual operation, the firmware loading apparatus 100 is connected to the USB device 200 through the USB connector 10, and loads the firmware data from the USB device 200 into the non-volatile memories 51, 52, 53, 54. Once the firmware data is loaded into the non-volatile memories 51, 52, 53, 54, the USB device 200 can be disconnected from the USB connector 10. The firmware stored in the non-volatile memories 51, 52, 53, 54 can be loaded into the IC 300 when the IC 300 is plugged in the IC slot 61, 62, 63, 64 without further connection to the USB device 200. Only when the firmware requires updates, the USB device is connected to the USB connector 10 for loading the updated firmware into the non-volatile memories 51, 52, 53, 54.

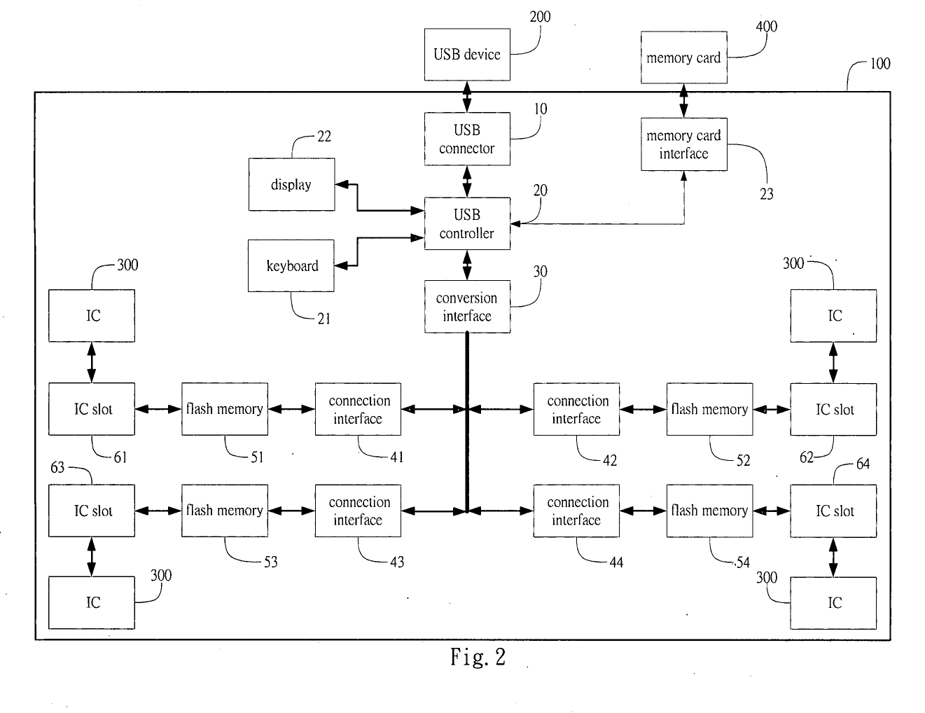

FIG. 2 shows a second embodiment of apparatus 100 in accordance with the present invention, where the USB controller 20 is connected to a keyboard 21, a display 22, and a memory card interface 23. After inputting data loading command through the keyboard 21 to the USB controller 20, the USB controller 20 executes the data loading operation, and the display 22 displays the operation status of the firmware data loading. The display 22 is not limited to any specific type. The present invention uses an LED as an embodiment for explanation. Other equivalent types, such as LCD, are also within the scope of the present invention. The memory card interface 23 provides connection to a memory card 400. The firmware for the IC 300 can be loaded from the memory card 400 into the USB controller 20.

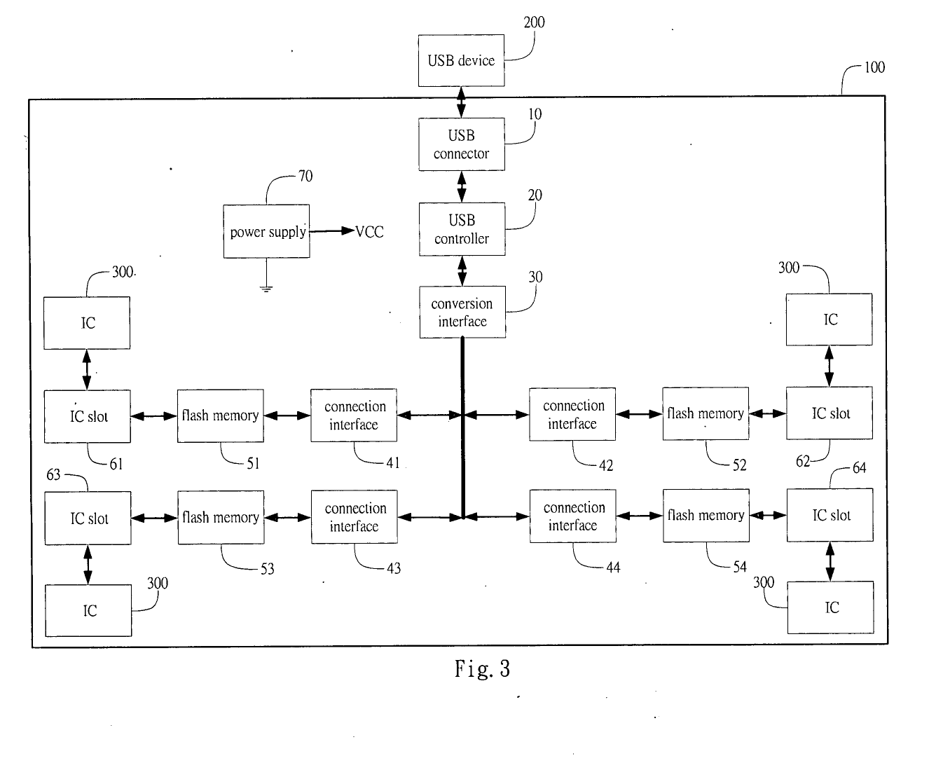

FIG. 3 shows a third embodiment of the apparatus 100 in accordance with the present invention, where a power supply 70 comprises a voltage source VCC connecting the USB controller 20, the conversion interface 30, the connection interfaces 41, 42, 43, 44, the non-volatile memories 51, 52, 53, 54 and the IC slots 61, 62, 63, 64 for supplying operation power. The apparatus 100 of the present invention can be powered by the power supply 70, in addition to drawing power from the USB interface of the USB device 200. The power supply 70 is not limited to any specific type. The present invention uses DC battery as an embodiment for explanation. Other equivalent types, such as AC power supply, are also within the scope of the present invention.

While the invention has been described in connection with what is presently considered to the most practical and preferred embodiments, it is to be understood that the invention is not to be limited to the disclosed embodiment, but on the contrary, is intended to cover various modifications and equivalent arrangement included within the spirit and scope of the appended claims.

What is claimed is:

1. An apparatus for loading firmware into an integrated circuit (IC), comprising:
at least a USB connector, for connecting to a USB device, the USB device storing an original firmware data for the IC;
at least a USB controller, connected to the USB connector, for loading the original firmware data from the USB device;
a conversion interface, connected to the USB controller, for converting the original firmware data into a corresponding interface data format;
a plurality of connection interfaces, corresponding to the conversion interface for connecting and loading the converted firmware data;
a plurality of non-volatile memories, connected to respective connection interfaces, for storing the converted firmware data; and
a plurality of IC slots for the IC to plug in for loading the firmware data stored in the non-volatile memories into the IC.

2. The apparatus as claimed in claim 1, wherein the USB controller is connected to a keyboard and a display.

3. The apparatus as claimed in claim 2, wherein the display comprises an LED.

4. The apparatus as claimed in claim 1, wherein the USB controller is connected to a memory card interface.

5. The apparatus as claimed in claim 1, wherein the USB controller is a USB OTG controller.

6. The apparatus as claimed in claim 1, wherein the conversion interface converts USB interface data format into parallel interface data format.

7. The apparatus as claimed in claim 1, wherein the connection interface is a parallel interface.

8. The apparatus as claimed in claim 1, wherein the non-volatile memory is a flash memory.

9. The apparatus as claimed in claim 1, wherein the USB controller, the conversion interface, the connection interfaces, the non-volatile memories, and the IC slots are connected to a power supply.

10. The apparatus as claimed in claim 9, wherein the power supply comprises a DC battery.
